(19) United States
(12) Patent Application Publication
(10) Pub. No.: US 2022/0197217 A1
(43) Pub. Date: Jun. 23, 2022

(54) Spherical Oscillator for a Timepiece Mechanism

(71) Applicant: LVMH Swiss Manufactures SA, La Chaux-de-Fonds (CH)

(72) Inventors: Thomas MERCIER, La Chaux-de-Fonds (CH); Guy Semon, Evette-Salbert (FR)

(73) Assignee: LVMH Swiss Manufactures SA, La Chaux-de-Fonds (CH)

(21) Appl. No.: 17/601,510

(22) PCT Filed: Mar. 26, 2020
(86) PCT No.: PCT/EP2020/058593

§ 371 Date: Oct. 5, 2021

(30) Foreign Application Priority Data
Apr. 5, 2019 (FR) FR1903703

(51) Int. Cl. G04B 17/04; G04B 17/10

(52) U.S. Cl. CPC G04B 17/045; G04B 17/10

(57) ABSTRACT

The oscillator for a regulator of a timepiece mechanism comprises a frame, a rigid body and a mechanism) for connecting the rigid body to the frame enabling oscillations of the rigid body relative to the frame. The connecting mechanism comprises at least one first and one second rigid parts, and a first and a second flexible elements, in the form of angular sectors of rings. The first and second flexible elements extend mainly in separate non-parallel planes. The first and second flexible elements are concentric. The first and second flexible elements each connect the first and second rigid parts together.

### TECHNICAL FIELD

The present invention relates to an oscillator for a regulator of a timepiece mechanism, to a mechanism and to a movement for a timepiece comprising such an oscillator and a timepiece comprising such a timepiece mechanism. According to another aspect, the invention relates to a method of manufacturing an oscillator for a timepiece.

### PRIOR ART

Mechanisms for timepieces are known, comprising:

a regulator or oscillator, comprising at least one first regulating member mounted elastically on a support to oscillate,
a pallet adapted to cooperate with an energy distribution member provided with teeth and intended to be biased by an energy storage device, the pallet being controlled by the first regulating member to regularly and alternately lock and release the energy distribution member, such that the energy distribution member is moved increment by increment under the bias of the energy storage device according to a repetitive movement cycle. The pallet is adapted to transfer mechanical energy to the regulator during this repetitive movement cycle. The oscillating member of the regulator generally has the form of a flat wheel. It is conventionally rotatably mounted on a central shaft.

The invention aims to propose an oscillator presenting a design that is different from existing designs, while preferably being balanced in rotation.

### SUMMARY OF THE DESCRIPTION

To this end, an oscillator is proposed for regulating the timepiece mechanism comprising a frame, a rigid body and a mechanism for connecting the rigid body to the frame enabling oscillations of the rigid body relative to the frame, the connecting mechanism comprising at least one first and one second rigid parts, and a first and a second flexible elements, in the form of angular sectors of rings, the first and second flexible elements extending mainly in separate, non-parallel planes, the first and second flexible elements being concentric, the first and second flexible elements each connecting the first and second rigid parts together.

The oscillator may present one or more of the following characteristics, taken alone or in combination:

the connecting mechanism comprises at least one third flexible element and at least one fourth flexible element, symmetrical with the first and second flexible elements, respectively, relative to the common center of the first and second flexible elements;
the first and second flexible elements are identical;
the common center of the first and second flexible elements corresponds to the center of gravity of the oscillator;
one and/or the other of the first and second flexible elements extend(s) on an angular sector of between 10° and 180°, preferably between 45° and 135°, more preferable between 80° and 100°;
the first and second flexible elements extend in planes forming between them an angle of between 40° and 120°;
the first and second flexible elements have constant thicknesses;
the mean radius of the first and/or second flexible element(s) is between 0.2 mm and 2 mm;
the first and/or second flexible element or elements are/is flexible blades;
the first and/or second flexible elements are/is formed by a plurality of rigid parts, preferably substantially planar, joined together in pairs by means of a flexible part;
the first and/or second flexible element(s) and at least one among the first rigid part and the second rigid part are made by implementing a method for superimposing planar layers and deploying the multilayer structure thus obtained;
the oscillator is designed to oscillate at a frequency equal to or greater than 4 Hz, preferably equal to or greater than 5 Hz, and/or equal to or less than 500 Hz, preferably equal to or less than 50 Hz, more preferably equal to or less than 15 Hz;
the first rigid part is the frame and the second rigid part is the rigid body;
the connecting mechanism comprises two first pairs of flexible elements, each of the flexible elements of each of the first pairs of flexible elements connecting the frame to a first respective intermediate rigid part, and two second pairs of flexible elements, each of the flexible elements of each of the second pairs of flexible elements connecting a first respective intermediate rigid part, to the rigid body, the elements of the first and second pairs of flexible elements being in the form of angular sectors of rings, the flexible elements of the first and second pairs of flexible elements extending in pairs in separate, non-parallel planes, the flexible elements of the first and second pairs of flexible elements being concentric; and
the connecting mechanism also comprises two third pairs of flexible elements, each of the flexible elements of each of the third pairs of flexible elements connecting the frame to a second respective intermediate rigid part, and two fourth pairs of flexible elements, each of the flexible elements of each of the fourth pairs of flexible elements connecting one of the second respective intermediate rigid parts to the rigid body, the first and third pairs of flexible elements being symmetrical relative to the center of the flexible elements of the first pair of flexible elements and the second and fourth pairs of flexible elements being symmetrical relative to the center of the flexible elements of the second pair of flexible elements.

According to another aspect, a mechanism for a timepiece is proposed, comprising:

an oscillator as described above in all its combinations,
a pallet adapted to cooperate with an energy distribution member and intended to be biased by an energy storage device, said pallet being controlled by the oscillator to regularly and alternately lock and release the energy distribution member, such that said energy distribution member is moved increment by increment under the bias of the energy storage device according to a repetitive movement cycle, and said pallet being adapted to transfer mechanical energy to the oscillator during this repetitive movement cycle.

The oscillator may also comprise:

a second oscillating member mounted elastically on the frame for oscillation, the first and second oscillating members being interconnected to always have symmetrical and opposed movements, and
a balancing member that is controlled by the second oscillating member to move according to movements that are symmetrical and opposed to the pallet.

According to another aspect, a timepiece movement is proposed comprising a mechanism as described above in all its combinations and said energy distribution member.

According to another aspect, a timepiece is proposed comprising a timepiece movement as described above in all its combinations.

According to yet another aspect, a method is proposed for producing an oscillator as described above in all its combinations, comprising:

the production of flexible blades;
the superimposition of layers forming at least one among the frame, the rigid body, the first rigid part and the second rigid part; and
the fixation of flexible blades to the at least one among the frame, the rigid body, the first rigid part and the second rigid part.

The flexible blades may be produced by superimposing layers, at least one of which is flexible relative to the others, and by deploying the flexible blades such that each of the blades extends mainly in a plane separate from the extension plane of the layer superimposition.

### BRIEF DESCRIPTION OF THE DRAWINGS

Other characteristics, details and advantages of the invention will appear upon reading the detailed description below, and analyzing the attached drawings, in which:

FIG. 1 is a schematic view of a timepiece comprising a mechanism for a timepiece;

FIG. 2 is a block diagram of the movement of the timepiece from FIG. 1;

FIG. 3 is a perspective view of a first example of an oscillator that may be implemented in the movement of FIG. 2, at rest;

FIG. 4 is a perspective view of the first example of an oscillator in a first oscillation position;

FIG. 5 is a perspective view of the first example of an oscillator in a second oscillation position;

FIG. 6 illustrates a step of an example method for making the first example of an oscillator;

FIG. 7 schematically represents a second example of an oscillator;

FIG. 8 is a perspective view of a third example of an oscillator;

FIG. 9 is a top view of the third example of an oscillator, in a first oscillation position;

FIG. 10 is a side view of the third example of an oscillator, in the first oscillation position;

FIG. 11 is a top view of the third example of an oscillator, in a second oscillation position; and

FIG. 12 is a side view of the third example of an oscillator, in the second oscillation position.

### DETAILED DESCRIPTION

In the different figures, the same references designate identical or similar elements.

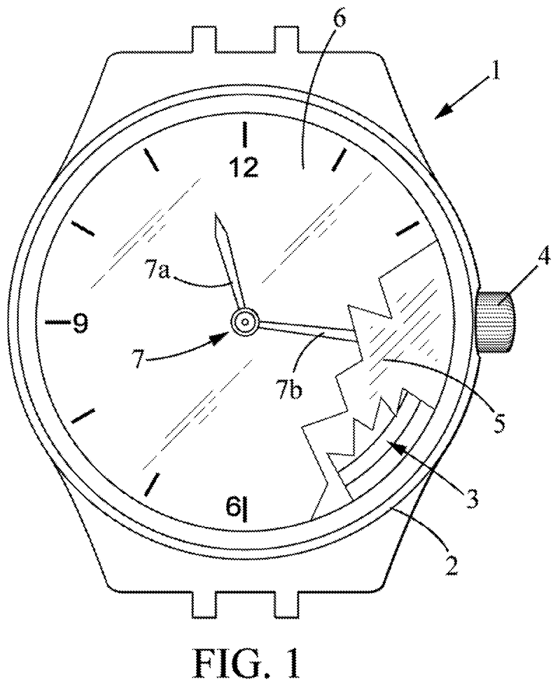

La FIG. 1 represents a timepiece 1 such as a watch, comprising:

a case 2,
a timepiece movement 3 contained in the case 2,
generally, a winding mechanism 4,
a dial 5,
a crystal 6 covering the dial 5,
a time indicator 7, comprising for example two hands 7a, 7b for the hours and minutes respectively, placed between the crystal 6 and the dial 5 and actuated by the timepiece movement 3.

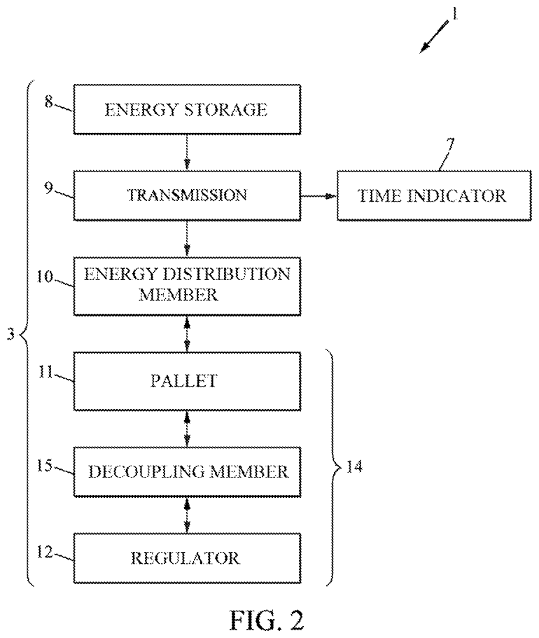

As represented schematically in FIG. 2, the timepiece movement 3 may comprise, for example:

a device 8 for storing mechanical energy, generally a barrel spring,
a mechanical transmission 9 driven by the device 8 for storing mechanical energy,
the abovementioned time indicator 7,
an energy distribution member 10 (for example an escape wheel),
a pallet 11 adapted to sequentially retain and release the energy distribution member 10,
a regulator 12, which is a mechanism comprising an oscillating inertial regulating member (or oscillator) 13, controlling pallet 11 to move it regularly such that the energy distribution member 10 is moved increment by increment at constant time intervals.

Pallet 11 and regulator 12 form a mechanism 14.

A decoupling member 15 may be interposed between the decoupling member and the regulator, which is thus part of the mechanism 14.

Energy distribution member 10 may be an escape wheel rotatably mounted for example on a support base, so as to be able to turn around an axis of rotation perpendicular to the median plane XY of mechanism 14. Energy distribution member 10 is biased by energy storage device 8 in a single rotation direction.

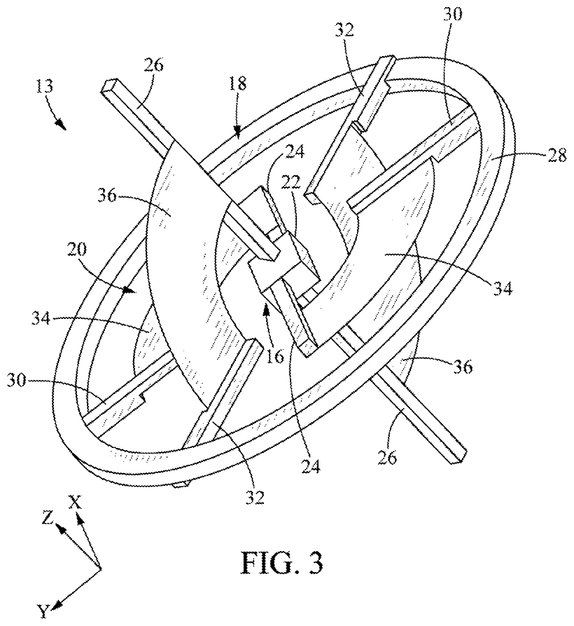

Regulator 12 may comprise an oscillator 13, a first example of which is illustrated in FIGS. 3 to 5.

As seen in these figures, oscillator 13 essentially comprises a fixed frame 16, a rigid oscillating body 18 and a mechanism 20 for connecting frame 16 to rigid body 18, enabling oscillations of rigid body 18 relative to the frame. It should be noted that, according to the example illustrated, fixed frame 16 is situated substantially in the center of oscillator 13, while rigid oscillating body 18 is on the periphery. However, the opposite configuration is also possible, in which immobilized rigid body 18 becomes a peripheral frame, and in which central “frame” 16 oscillates owing to connecting mechanism 20.

More specifically, here fixed frame 16 comprises a central part 22, in this case substantially having the shape of a rectangular parallelepiped. Two identical first arms 24 extend from this central part 22. Here the first arms 24 are symmetrical relative to the center of oscillator 13. In this case, first arms 24 extend along direction X of the length of central part 22. Frame 16 also comprises two identical second arms 26. Here second arms 26 are symmetrical relative to the center of oscillator 13. Second arms 26 substantially extend along direction Z of the height of central part 22 of frame 16. Thus, second arms 26 extend along direction Z normal to extension direction X of first arms 24. Second arms 26 may be substantially longer than first arms 24, to enable fixation of frame 16 of oscillator 13 in case 2 of timepiece 1, while enabling oscillations of oscillator 13.

Oscillator 13 also comprises a rigid body 18. Here rigid body 18 comprises a circular part 28. Two pairs of arms 30, 32 extend radially inward from circular part 28 of rigid body 18. The two arms 30 of first pair of arms 30 are substantially identical and are symmetrical relative to the center of gravity of oscillator 13, which here corresponds to the geometric center of the oscillator. In addition, two arms 32 of second pair of arms 32 are substantially identical and are symmetrical relative to the center of gravity of oscillator 13. Here it should be noted that first and second arms 30, 32 do not extend to frame 16, so as to leave clearance between frame 16 and rigid body 18.

Each first arm 24 of frame 16 is connected to a first arm 30 of rigid body 18 by a first flexible blade 34. In addition, each second arm 26 of frame 16 is connected to a second arm 32 of rigid body 18 by a second flexible blade 36. Here, the first and second flexible blades 34, 36 are identical. Here, first and second flexible blades 34, 36 have the shape of an angular ring sector. In this case, first and second flexible blades 34, 36 have the shape of a quarter ring. Flexible blades 34, 36 may present a substantially constant thickness. As a variant, however, first and second flexible blades 34, 36 have a lower thickness radially towards the center of oscillator 13. For example, first and second flexible blades 34, 36 have a substantially trapezoidal section, such that two sides of the section are substantially secant to the center of oscillator 13.

First and second flexible blades 34, 36 are concentric, the center corresponding here to the center of oscillator 13.

Here, first and second flexible blades 34, 36 form connecting mechanism 20 between frame 16 and rigid body 18, which enables oscillations of rigid body 18 relative to frame 16. It should be noted here that a connecting mechanism 20 comprising a single first flexible blade 34 and a single second flexible blade 36 already enables oscillations of rigid body 18 relative to frame 16. However, the implementation of two first flexible blades 34, symmetrical relative to the center of oscillator 13, and two second flexible blades 36 that are also symmetrical relative to the center of oscillator 13, enables oscillator 13 to be better balanced.

It should also be noted that here each of the first and second flexible blades 34, 36 is in one piece. The first and second flexible blades may be made in a same material as frame 16 and rigid body 18. The flexible blades present an aspect ratio and a slenderness ratio that ensure satisfactory flexibility to the blades. Here, aspect ratio is understood to refer to the ratio between the width and the thickness of the flexible blade. Here, slenderness ratio is understood to refer to the ratio between the length and the thickness of the flexible blade. The length of a flexible blade is here defined as the length of the neutral fiber of the flexible blade. In this example where the flexible blades are ring sectors, the width of a flexible blade is defined as the difference between the external radius and the internal radius of the flexible blade. Thickness of a flexible blade shall be understood to be the third dimension of the flexible blade. Typically, the thickness of a blade is much less than the length and width of this blade. In particular, the thickness of a blade is ten times less, or even one hundred times less, than the length and/or width of the blade.

First and second flexible blades 34, 36 may be in one piece with frame 16 and/or rigid body 18. In this case, as indicated previously, the flexibility of flexible blades 34, 36 relative to frame 16 and rigid body 18 may, in particular, be obtained by producing flexible blades 34, 36 in which the aspect ratio is less than the aspect ratio of frame 16 and/or rigid body 18. In particular, the aspect ratio of flexible blades 34, 36 is ten times less, preferably one hundred times less, than the aspect ratio of frame 16 and/or rigid body 18. In other embodiments, the first and second flexible blades may be made in a material that is different from the material(s) forming frame 16 and rigid body 18.

However, other flexible elements may be implemented instead of flexible blades 34, 36. For example, the flexible elements may be made by combining the rigid parts that are connected in pairs through a flexible part or a flexible blade, i.e., more flexible than the rigid parts. The rigid and flexible parts may be in one piece or may be connected to each other.

In the example illustrated, flexible blades 34, 36 substantially form a quarter ring. However, more generally, flexible blades 34, 36 may extend over an angular sector corresponding to a center angle greater than 10°, preferably greater than 45°, more preferably greater than 80° and/or less than 180°, preferably less than 135°, more preferably less than 100°. In general, the wider the angle at the center of flexible blades 34, 36, the higher the risk of these flexible blades 34, 36 collapsing. Conversely, the smaller the angle at the center, the less the flexible blades 34, 36 are a priori flexible.

Also, the mean radius of flexible blades 34, 36, may advantageously be between 0.2 mm and 2 mm. Here, mean radius is understood to refer to the arithmetic mean of the inner radius and the outer radius.

Alternatively or in addition, the ratio between the inner radius and the outer radius of each flexible blade 34, 36 may be equal to or greater than 1/10, preferably equal to or greater than 4/10, and/or equal to or less than 9/10, preferably equal to or less than 8/10.

As seen in FIG. 3, oscillator 13 being fixed, at rest, first flexible blades 34 extend in a first plane, second flexible blades 36 extend in a second plane such that the first and second planes are separate. The first and second planes are also not parallel. In this case, the first and second planes are substantially perpendicular. In a variant, flexible blades 34, 36 may also extend in planes forming an angle of between 40° and 120° between them.

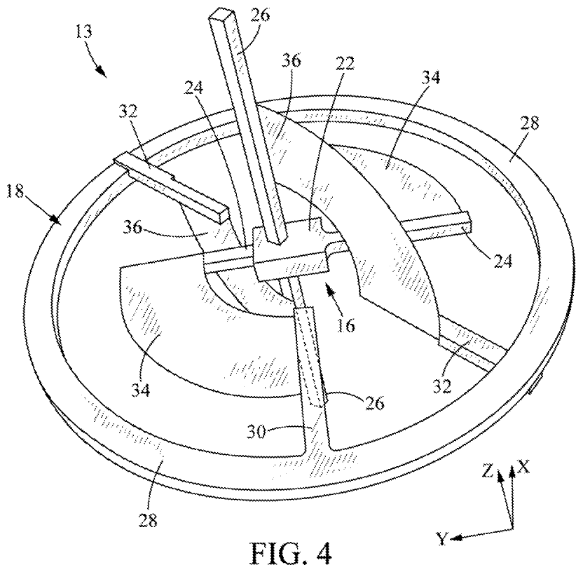

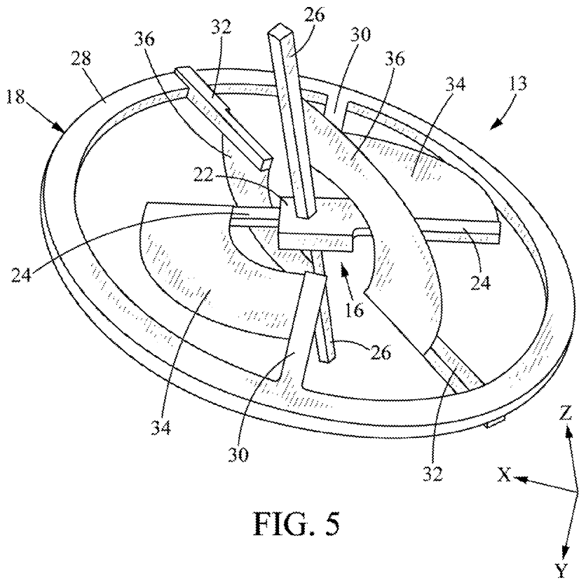

FIGS. 4 and 5 illustrate two positions of oscillator 13. In this case, the oscillations of rigid body 18 relative to frame 16 are relatively complex, which substantially corresponds to a rotation around an instantaneous mobile axis of rotation, the instantaneous mobile axis of rotation always passing by the center of oscillator 13.

Oscillator 13 of FIGS. 3 to 5 may advantageously be made in whole or in part by implementing a method of the “pop-up” type, an example of which is described in application WO2018/197516 A1. In particular, flexible blades 34, 36 may be made by implementing such a method. Here, “pop-up” type method is understood to refer to a manufacturing method comprising a superimposition of layers (or sheets) of materials, pre-cut if appropriate, and a deployment of the multilayer structure thus obtained. Such a method enables to obtain, following deployment, flexible blades with optimal aspect ratios that extend in separate planes, non-parallel to the median plane of the oscillator.

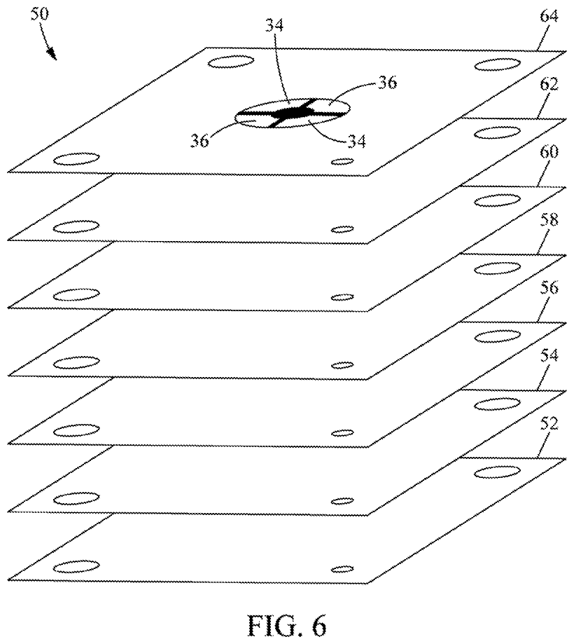

In particular, FIG. 6 illustrates a step of such a method, during which the first and second flexible blades 34, 36 are made, and they are positioned so that they can easily assembled thereafter with frame 16 and rigid body 18.

Thus, FIG. 6 represents an assembly 50 of seven separate layers 52, 54, 56, 58, 60, 62, 64 among which:

a first layer 52 is in a first material, preferably rigid;
a second layer 54 is a layer of glue or adhesive material to ensure fixation of the first layer 52 to a third layer 56;
the third layer 56 is in a flexible material. In particular, the flexible material may be a polymeric film, for example a polyimide. By way of example, the flexible material may be Kapton®;
a fourth layer 58 is a layer of glue or adhesive material to ensure fixation of the third layer 56 to a fifth layer 58;
the fifth layer 60 is in a second material, preferably rigid, which may advantageously be the same as the first material;
a sixth layer 62, which is a layer of glue or adhesive material to ensure fixation of the fifth layer 58 to a seventh layer 64;
the seventh layer 64, which may be in a material that is different from the first and from the second materials or which may be one among the first and the second materials. This seventh layer 64 may alternatively or in addition be thinner than the first and fifth layers 52, 60, particularly in the case where all these layers 52, 60, 64 are in a same material. Flexible blades 34, 36 are formed in this seventh layer 64.

The first and third layers 52, 56 enable sacrificial structures to be made, which may include flexible connections ensured by third layer 56. To do this, various cuts are made in layers 52-64 so as, in particular, to create incipient folds and/or incipient breaks. Cuts made in seventh layer 64 enable flexible blades 34, 36 to be defined.

The sacrificial structures form one or more “mounting scaffold(s)” facilitating the deployment of assembly 50. The sacrificial structures may enable various movements necessary for the deployment of the multilayer assembly 50 to be connected.

Here, by deploying the assembly, the various flexible blades 34, 36 necessary for making the connecting mechanism 20 described previously may be positioned.

According to an embodiment, the frame and/or the oscillating body are made separately from flexible blades 34, 36 and they are assembled to flexible blades 34, 36 after deployment of these flexible blades 34, 36. The frame and/or the rigid body may then also be made by implementing a method of the “pop-up” type, either separately or concomitantly.

According to a variant, the frame and/or the oscillating body are made concomitantly with the flexible blades. In this case, the frame and/or the oscillating body may be made on layers that are separate from the layer in which flexible blades 34, 36 are formed, possibly separate.

Frame 16 and/or oscillating body 18 may, in particular, be in one from among tungsten, molybdenum, gold, silver, tantalum, platinum, alloys containing these elements, a polymer material loaded with particles of a density greater than ten, particularly particles of tungsten, steel, a copper alloy, particularly brass. These materials are indeed heavy. Other materials that may be implemented are also accessible to the person skilled in the art.

Frame 16 and/or oscillating body 18 may also be in a material chosen from among silicon, glass, sapphire or alumina, diamond, particularly synthetic diamond, particularly the synthetic diamond obtained by a chemical vapor phase deposition process, titanium, a titanium alloy, particularly an alloy of the Gum metal® family and an alloy of the Elinvar family, particularly Elinvar®, Nivarox®, Thermelast®, NI-Span-C® and Precision C®.

In fact, these materials present the advantage that their Young's modulus is very insensitive to temperature variations. This is particularly advantageous in the field of timepieces, so that oscillator 13 maintains its precision, even in the event of temperature variations.

Gum metals® are materials comprising: 23% niobium; 0.7% tantalum; 2% zirconium; 1% oxygen; optionally vanadium; and optionally hafnium.

Elinvar alloys are nickel-steel alloys comprising nickel and chromium that are very insensitive to temperatures. Elinvar®, in particular, is a nickel-steel alloy, comprising 59% iron, 36% nickel and 5% chromium.

NI-Span-C ® comprises between 41.0 and 43.5% nickel and cobalt; between 4.9 and 5.75% chromium; between 2.20 and 2.75% titanium; between 0.30 and 0.80% aluminum; not more than 0.06% carbon; not more than 0.80% manganese; not more than 1% silicon; not more than 0.04% sulfur; not more than 0.04% phosphorus; and the supplemental iron needed to reach 100%.

Precision C® comprises: 42% nickel; 5.3% chromium; 2.4% titanium; 0.55% aluminum; 0.50% silicon; 0.40% manganese; 0.02% carbon; and the supplemental iron needed to reach 100%.

Nivarox® comprises: between 30 and 40% nickel; between 0.7 and 1.0% beryllium; between 6 and 9% molybdenum and/or 8% chromium; optionally, 1% titanium; between 0.7 and 0.8% manganese; between 0.1 and 0.2% silicon; carbon, up to 0.2%; and the supplemental iron.

Thermelast® comprises: 42.5% nickel; less than 1% silicon; 5.3% chromium; less than 1% aluminum; less than 1% manganese; 2.5% titanium; and 48% iron.

All the compositions above are indicated in percentages by weight.

Flexible blades 34, 36 are, for example, in steel.

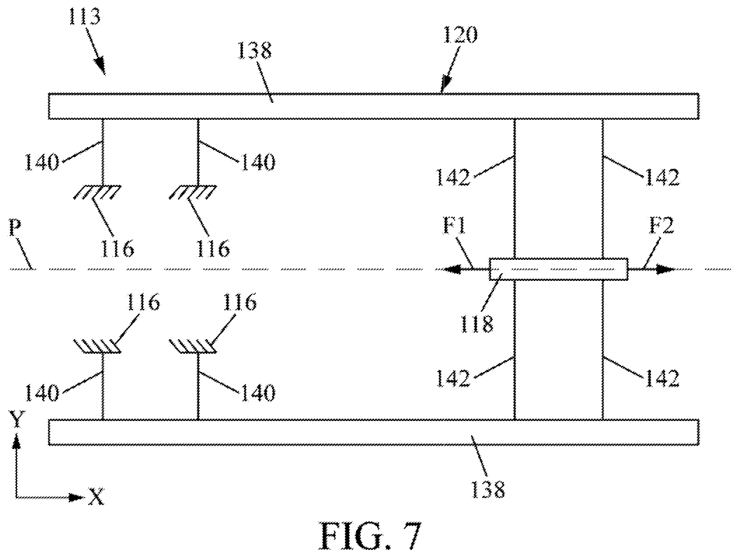

FIG. 7 illustrates an example of an oscillator 113 presenting a main degree of freedom. More specifically, in oscillator 113 of FIG. 7, rigid body 118 mainly oscillates relative to the frame according to a translational back-and-forth movement illustrated by arrows F1, F2. To obtain this rigid body 118 movement, rigid body 118 is connected to frame 116 through a connecting mechanism 120, which comprises:

two identical intermediate rigid bodies 138;
two first flexible blades 140 between each of the two intermediate rigid bodies 138 and frame 116;
two second flexible blades 142 between each of the two intermediate rigid bodies 138 and the oscillating rigid body 118. In this case, first and second flexible blades 140, 142 are identical. It should be noted here that first and second flexible blades 140, 142 of oscillator 113 are, at rest, rectilinear and extend in planes parallel to each other and perpendicular to the main plane (i.e., the plane from FIG. 7).

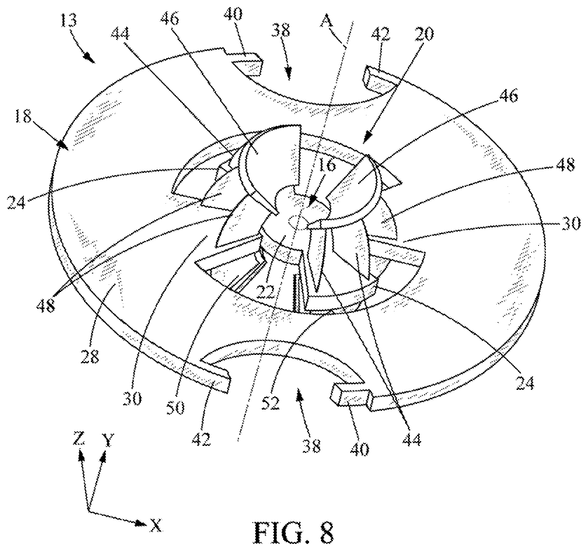

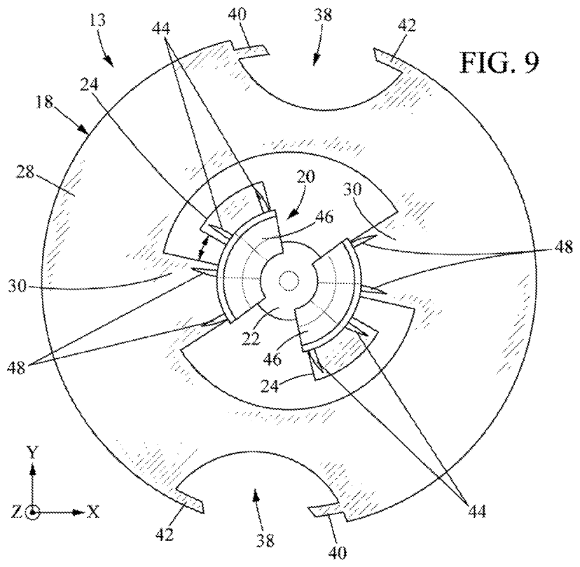

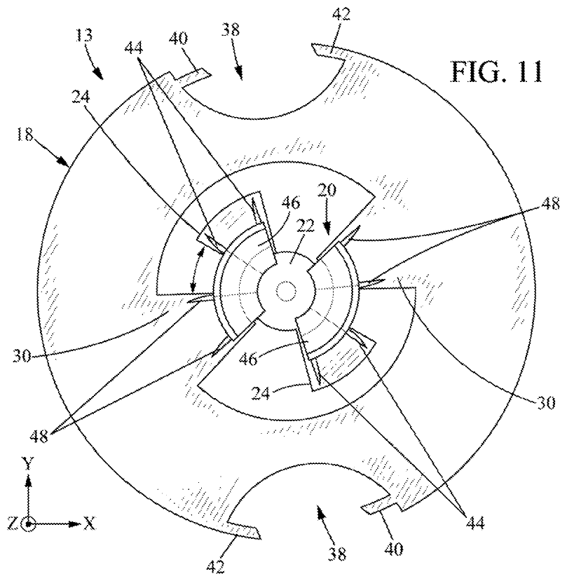

FIGS. 8 to 12 illustrate a third example of an oscillator 13. In this third example, elements that are identical or of identical function with elements from the third example bear the same numerical reference sign.

Oscillator 13 from FIGS. 8 to 12 may be deduced from oscillator 113 from FIG. 7 by transforming oscillator 13 such that the axes perpendicular to the main plane become convergent. By this transformation, the main plane becomes a sphere, the convergent axes passing by the center of this sphere. Thus, flexible blades 140, 142 of oscillator 113, in particular, are replaced with flexible blades (or more generally, flexible elements) that are portions of rings extending in separate and non-parallel planes, the flexible blades of oscillator 13 from FIGS. 8 to 12 also being arranged so as to be concentric. As a result, such an oscillator 13 with eight such flexible blades already presents a rigid body, oscillating in rotation. However, the oscillator from FIG. 8 comprises eight additional flexible blades, symmetrical with the eight blades mentioned above, relative to the center of oscillator 13. These additional flexible blades allow oscillator 13 to be better balanced.

In addition, by carrying out the above operation, the oscillating body is found at the center of oscillator 13 and the frame at the periphery. However, as already indicated for the first oscillator example, in practice, it is sufficient to lock the central part so that this part is the frame and the part at the periphery can oscillate relative to this frame.

Thus, oscillator 13 from FIGS. 8 to 12 more specifically comprises a frame 16 connected to oscillating rigid body 18 by means of a connecting mechanism 20, enabling rigid body 18 to oscillate relative to frame 16. Here, rigid body 18 oscillates in rotation around central fixed axis A of oscillator 13. In the example, central part 22 of frame 16 has the shape of a disk, from which two first arms 24, which here substantially have the shape of angular sectors of rings, extend. As in the first example, these two first arms 24 are identical and symmetrical with relation to the center of oscillator 13.

Oscillator 13 also comprises rigid body 18, in this case located radially outward relative to frame 16. In the illustrated example, rigid body 18 comprises a circular part 28 with, in this case, two lateral reinforcements 38 in which two teeth 40, 42 extend, substantially along an orthoradial direction. A first tooth 40 is situated radially closer to the center of oscillator 13 than a second tooth 42. This shape of rigid body 18 with two lateral reinforcements 38 enables better balancing of the rigid body. However, in practice, a single lateral reinforcement 38 with two teeth 40, 42 may suffice to implement the oscillator and associate it with an escapement, particularly a Graham type escapement. A second reinforcement 38 may be provided in order to balance rigid body 18, this second reinforcement 38 may not be provided with teeth 40, 42.

In the illustrated example, rigid body 18 comprises two first identical arms 30, which are in this case symmetrical relative to the center of oscillator 13. The two first arms 30 of rigid body 18 here substantially have the shape of an angular ring sector.

Here, frame 16 is connected to rigid body 18 by means of connecting mechanism 20, described below, allowing rigid body 18 to oscillate relative to frame 16, substantially by rotation around an axis A normal to the common extension plane.

Connecting mechanism 20 comprises, in the example illustrated in FIGS. 8 to 12, two first pairs of flexible blades 44, each first pair of flexible blades 44 connecting an arm 24 of frame 16 to a first rigid, respective intermediate part 46. The two first intermediate parts 46 are substantially identical. Here, the two first intermediate parts 46 have the shape of an angular sector of a truncated cone. However, first intermediate parts 46 may take many other shapes, particularly other portions of quadric surfaces. Advantageously, two first intermediate parts 46 extend perpendicular to arms 24 of frame 16 and to arms 30 of rigid body 18. In addition, each first intermediate part 44 is connected to one of the arms 30 of rigid body 18, by a second pair of flexible blades 48. Thus, each intermediate part 44 essentially has the function of connecting one first pair of flexible blades 44 to a second pair of flexible blades 48.

Oscillator 13 being at rest, the angular deviation between the planes along which flexible blades 44 of a first pair of flexible blades 44 extend, is substantially identical to the angular deviation between the planes along which flexible blades 48 of a second pair of flexible blades 48 extend. More generally, flexible blades 44, 48 may extend along planes that are inclined relative to the vertical direction, normal to the extension plane of the frame and of the rigid body in the illustrated example. Flexible blades 44, 48 of the first and second pairs of flexible blades are substantially identical to the flexible blades of the first example described above, particularly regarding their shapes.

In addition, to ensure better balancing of oscillator 13, connecting mechanism 20 is substantially symmetrical relative to the center of oscillator 13. Thus, each arm 20 of frame 16 is connected to a second respective intermediate part 50, the image of a first intermediate part relative to the center of oscillator 13, by means of a third pair of flexible blades 52. Each of the two second intermediate parts 50 is substantially identical to the first intermediate parts 46 with which they are symmetrical relative to the center of oscillator 13. Each of the flexible blades 52 of the third pairs of flexible blades 52 is symmetrical with a flexible blade 44 of a first pair of flexible blades 44, relative to the center of oscillator 13.

Lastly, each of the second intermediate parts 50 is connected to a respective arm 30 of rigid body 18 by means of a fourth pair of flexible blades 54. Each of the flexible blades 54 of the fourth pairs of flexible blades 54 is symmetrical with a flexible blade 48 of the second pairs of flexible blades, relative to the center of oscillator 13.

Thus, in connecting mechanism 20, first, second, third and fourth flexible blades 44, 48, 52, 54 are concentric, their centers corresponding to the center of oscillator 13.

Also in this second example, each of the pairs of first and third flexible blades 44, 52 is connected firstly to frame 16 and secondly to a rigid intermediate part 46, 50.

In this case, the first, second, third and fourth flexible blades 44, 48, 52, 54 are symmetrical relative to the center of gravity of oscillator 13. The first, second, third and fourth flexible blades 44, 48, 52, 54 are also, in the illustrated example, symmetrical relative to the extension plane of rigid body 24.

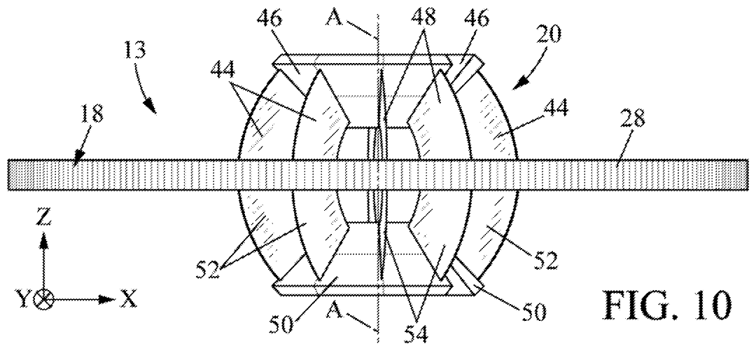

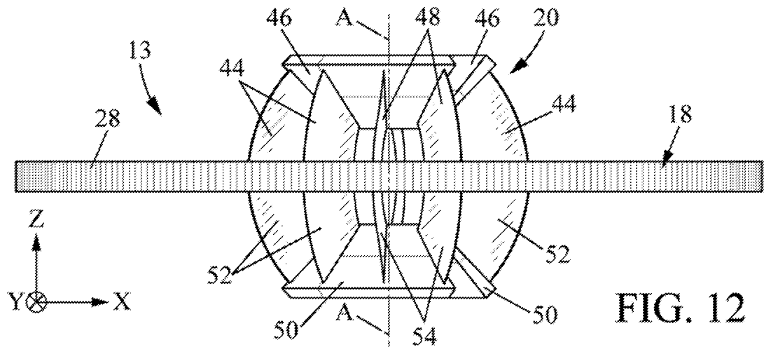

This second example presents the advantage that rigid body 18 substantially oscillates in its extension plane, as illustrated in FIGS. 10 and 12. More specifically, rigid body 18 oscillates in rotation relative to frame 16. The second oscillator 13 example may thus, in particular, be implemented to cooperate with a conventional Graham type escapement.

Advantageously, the two oscillators 13 described previously are shaped to oscillate at a frequency equal to or greater than 4 Hz, preferably equal to or greater than 5 Hz, and/or equal to or less than 500 Hz, preferably equal to or less than 50 Hz, still more preferably equal to or less than 15 Hz.

As with the first oscillator 13 example, the second oscillator 13 example illustrated in FIGS. 8 to 12, may advantageously be made in whole or in part by means of a “pop-up” type method.

Advantageously, such a method makes it possible to produce oscillators, particularly oscillator blades, with reduced dimensions, and with a high positioning accuracy of the various oscillator elements relative to each other.

The invention is not limited to the examples described above, only by way of example, but the invention encompasses all the variants that a person skilled in the art may envisage within the context of the protection sought.

In particular, in the examples described, one part has been described as a frame, the other part—the rigid body as oscillating. However, it should be noted that in these examples, it is possible to establish the rigid body as the frame, the other part, presented as the frame in the previous examples, becoming the oscillating rigid body.

Also, in the examples described, flexible blades are implemented. However, as mentioned in the description of the first example, flexible elements may more generally be implemented in connecting mechanism 20.

The geometry of frame 16, rigid body 18 and intermediate parts 46, 50 described in the examples is in no way limiting. Many other embodiments that are accessible to the person skilled in the art may be implemented.

1. An oscillator for a regulator a timepiece mechanism comprising a frame, a rigid body and a mechanism for connecting the rigid body to the frame enabling oscillations of the rigid body relative to the frame, the connecting mechanism comprising at least one first and one second rigid parts, and a first and a second flexible elements in the form of angular sectors of rings, the first and second flexible elements extending mainly in separate non-parallel planes, the first and second flexible elements being concentric, the first and second flexible elements each connecting the first and second rigid parts together.

2. The oscillator according to claim 1, in which the connecting mechanism comprises at least one third flexible element and at least one fourth flexible element, symmetrical with the first and second flexible elements respectively, relative to the common center of the first and second flexible elements.

3. The oscillator according to claim 1, in which the first and second flexible elements are identical.

4. The oscillator according to claim 2, in which the common center of the first and second flexible elements corresponds to the center of gravity of the oscillator.

5. The oscillator according to claim 1, in which at least one of the first and second flexible elements extend over an angular sector of between 10° and 180°.

6. The oscillator according to claim 1, in which the first and second flexible elements extend in planes forming an angle of between 40° and 120° between them.

7. The oscillator according to claim 1, in which the first and second flexible elements have constant thicknesses.

8. The oscillator according to claim 1, in which the mean radius of at least one of the first and the second flexible element is between 0.2 mm and 2 mm.

9. The oscillator according to claim 1, in which at least one of the first and the second flexible element is a flexible blades.

10. The oscillator according to claim 1, in which at least one of the first and second flexible element (34, 36; 44; 48) is formed from a plurality of rigid parts joined together in pairs by means of a flexible part.

11. The oscillator according to claim 1, in which at least one of the first and the second flexible elements and the at least one among the first rigid part and the second rigid part are made by implementing a method for superimposing planar layers and deploying the multilayer structure thus obtained.

12. The oscillator according to claim 1, designed to oscillate at a frequency equal to or greater than 4 Hz, and equal to or less than 500 Hz.

13. The oscillator according to claim 1, in which the first rigid part is the frame and the second rigid part is the rigid body.

14. The oscillator according to claim 1, in which the connecting mechanism comprises two first pairs of flexible elements, each of the flexible elements of each of the first pairs of flexible elements connecting the frame to a first respective intermediate rigid part, and two second pairs of flexible elements, each of the flexible elements of each of the second pairs of flexible elements connecting a first respective intermediate rigid part to the rigid body, the elements of the first and second pairs of flexible elements being in the form of angular sectors of rings, the flexible elements of the first and second pairs of flexible elements mainly extending in pairs in separate, non-parallel planes, the flexible elements of the first and second pairs of flexible elements being concentric.

15. The oscillator according to claim 14, in which the connecting mechanism also comprises two third pairs of flexible elements, each of the flexible elements of each of the third pairs of flexible elements connecting the frame to a second respective intermediate rigid part, and two fourth pairs of flexible elements, each of the flexible elements of each of the fourth pairs of flexible elements connecting one of the second respective intermediate rigid parts to the rigid body, the first and third pairs of flexible elements being symmetrical relative to the center of the flexible elements of the first pair of flexible elements and the second and fourth pairs of flexible elements being symmetrical relative to the center of the flexible elements of the second pair of flexible elements.

16. A mechanism for a timepiece comprising:
an oscillator according to claim 1,
a pallet adapted to cooperate with an energy distribution member and intended to be biased by an energy storage device, said pallet being controlled by the oscillator to regularly and alternately lock and release the energy distribution member, such that said energy distribution member is moved increment by increment under the bias of the energy storage device according to a repetitive movement cycle, and said pallet being adapted to transfer mechanical energy to the oscillator during this repetitive movement cycle.

17. The timepiece mechanism according to claim 16, in which the oscillator also comprises:
a second oscillating member mounted elastically on the frame for oscillation, the first and second oscillating members being interconnected to always have symmetrical and opposed movements, and
a balancing member that is controlled by the second oscillating member to move according to movements that are symmetrical and opposed to the pallet.

18. A timepiece movement comprising a mechanism according to claim 16 and said energy distribution member.

19. A timepiece comprising a timepiece movement according to claim 18.

20. A method for producing an oscillator according to claim 9 comprising:
the production of flexible blades;
the superimposition of layers forming at least one among the frame, the rigid body, the first rigid part and the second rigid part; and
the fixation of the flexible blades to the at least one among the frame, the rigid body, the first rigid part and the second rigid part.

21. The method according to claim 20, in which the flexible blades is made by superimposing layers, at least one of which is flexible relative to the others, and by deploying the flexible blades such that the flexible blades extends mainly in a plane separate from the extension plane of the layer superimposition.
